(19) United States
(12) Patent Application Publication
(10) Pub. No.: US 2002/0194071 A1
(43) Pub. Date: Dec. 19, 2002

(54) Reward system and apparatus used therefor

(75) Inventors: Hironori Yoshizaki, Nagano-ken (JP); Hiroaki Sekizawa, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/154,975

(22) Filed: May 28, 2002

(30) Foreign Application Priority Data
Jun. 18, 2001 (JP) 2001-182734
Apr. 12, 2002 (JP) 2002-110263

(51) Int. Cl. G06F 17/60

(52) U.S. Cl. 705/14

(57) ABSTRACT

The system of the present invention calculates a variation in balance between a commercial value and a price of an item before and after a predetermined revision and accumulates the calculated point in a Web server. When a customer who has purchased the item within a predetermined time period prior to a price revision or a functional revision of the item requires the Web server to output a customer's page allocated to the customer, the Web server displays the accumulated point in the customer's page. The Web server also displays specification of an available service corresponding to the accumulated point, for example, a discount on price of the item corresponding to the accumulated point. This arrangement of the system effectively wipes out the customer's feeling of loss due to the price revision or the functional revision of the item.

### BACKGROUND OF THE INVENTION

1. Field of the Invention

The present invention relates to a reward system and an apparatus used therefor. More specifically the present invention pertains to a reward system that gives a point to a customer who has purchased an item, as well as to an apparatus that calculates a point to be given to the customer who has purchased an item.

2. Description of the Prior Art

The conventional reward system accumulates a point to be given to a customer according to the price of each item purchased by the customer within a preset time period. For example, the system gives a point at a rate of 1 point per preset unit price to each item purchased by the customer within a preset time period like 2 year or 3 years. The system offers services corresponding to the accumulated point, such as a gift to the customer and a discount on price of an item that the customer purchases next time.

In the case of an item subjected to frequent price and functional revisions, there is a variation in balance between the commercial value and the price of the item before and after the revision. The customer who has purchased the item immediately before the revision may have a complaint and make a claim. The conventional reward system does not sufficiently resolve such dissatisfaction and claims of the customer.

### SUMMARY OF THE INVENTION

The object of the present invention is to provide a reward system and a point calculation apparatus that calculate a point based on a variation in balance between a commercial value and a price of an item before and after a certain revision of the item.

The object of the invention is also to provide a reward system and a point calculation apparatus that show each customer the calculated point.

The object of the invention is further to provide a reward system and a point calculation apparatus that show each customer the specification of an available service corresponding to the calculated point.

In order to achieve at least aforementioned objects, the reward system according to the present invention is structured as follows.

A reward system of the present invention is a reward system that gives a point to a customer who has purchased an item, the reward system including:

a revision point setting module that, in the case of a predetermined revision of an item, sets a variation in balance between a commercial value and a price of the item before and after the predetermined revision, as a revision point; and

a point calculation module that calculates a point to be given to a customer who has purchased the item, based on the item purchased within a time period of predetermined days prior to a date of the predetermined revision and the revision point set by the revision point setting module.

The reward system of the present invention calculates a point to be given to the customer who has purchased an item, based on the item purchased within a time period of predetermined days prior to the date of a predetermined revision of the item and the revision point set as the variation in balance between the commercial value and the price before and after the predetermined revision. Namely the variation in balance between the commercial value and the price before and after the predetermined revision of the item is calculated as the point. Here the ‘predetermined revision of the item’ includes either one or both of a price revision and a functional revision of the item.

In the reward system of the present invention, the point calculation module can calculate the point to be given to the customer, based on the revision point set by the revision point setting module within the predetermined time period. This arrangement calculates the point, only based on the revision point in the predetermined time period.

As one aspect, the reward system of the present invention can include a point output module that outputs the point calculated by the point calculation module. In this case the point output module can output the calculated point, in response to a request of the customer under a preset condition via a public network. This arrangement enables each customer to check the calculated point via the public network.

As another aspect, the reward system of the present invention can include a service setting module that sets a predetermined service corresponding to the point calculated by the point calculation module. In this case, ‘the predetermined service’ can give a discount on price of an item corresponding to the calculated point, when the customer purchases the item. Furthermore, the reward system of the present invention structured in this way can include a service specification output module that outputs specification of the predetermined service set by the service setting module. In this case, the service specification output module can output the specification of the predetermined service in response to a request of the customer under a preset condition via a public network. This arrangement enables each customer to check specification of the predetermined service via the public network.

As still another aspect, the reward system of the present invention can include a purchase point setting module that sets a purchase point relative to a purchase price of an item,

wherein the point calculation module can calculate the point to be given to the customer based on the revision point, while calculating the point to be given to the customer who has purchased the item based on the purchased item and the purchase point set by the purchase point setting module. This arrangement calculates the point, based on both the revision point and the purchase point. In this case, the point calculation module can calculate the point to be given to the customer, based on the purchase point set by the purchase point setting module in a predetermined time period. This arrangement calculates the point, only based on the purchase point in the predetermined time period.

The reward system of the present invention is the reward system that can further include an individual information storage module that stores individual information of the customer; and

a point notification module that notifies the customer of the point calculated by the point calculation module to be given to the customer, using the individual information of the customer stored in the individual information storage module. This arrangement enables each customer to be notified of the calculated point. In this case, the point notification module can notify the customer of the calculated point by an E mail.

A first point calculation apparatus of this invention is a point calculation apparatus that calculates a point to be given to a customer who has purchased an item, the point calculation apparatus including:

a revision point input module that inputs a revision point, which is set corresponding to a variation in balance between a commercial value and a price of an item before and after a predetermined revision of the item; and

a point calculation module that calculates a point to be given to a customer who has purchased the item, based on the revision point input by the revision point input module and the item purchased within a time period of predetermined days prior to a date of the predetermined revision.

The first point calculation apparatus of the present invention can calculate a point to be given to the customer who has purchased an item, based on the item purchased within a time period of predetermined days prior to the date of a predetermined revision of the item and the revision point set as the variation in balance between the commercial value and the price before and after the predetermined revision. Namely the variation in balance between the commercial value and the price before and after the predetermined revision of the item is calculated as the point. The calculated point is used as an index of a certain service given to the customer, corresponding to the variation in balance between the commercial value and the price of the item before and after the predetermined revision of the item. Here the ‘predetermined revision of the item’ includes either one or both of a price revision and a functional revision of the item.

In the first point calculation apparatus of the present invention structured in this way, the point calculation module can calculate a point corresponding to the predetermined revision of the item carried out in a predetermined time period. This arrangement enables calculation of the point corresponding to only the predetermined revision of the item in a certain time period.

The first point calculation apparatus of the present invention can further include a point output module that outputs the point calculated by the point calculation module. In this case, the point output module can output the calculated point, in response to a request of the customer under a preset condition via a public network. This arrangement enables each customer to check the calculated point via the public network.

The first point calculation apparatus of the present invention can still further include a purchase point input module that inputs a purchase point set relative to a purchase price of an item,

wherein the point calculation module can calculate the point to be given to the customer based on the revision point, while calculating a point to be given to the customer who has purchased the item based on the purchased item and the purchase point input by the purchase point input module. This arrangement calculates the point, based on both the revision point and the purchase point. In this case, the point calculation module can calculate a point assigned to the item purchased in a predetermined time period.

A second point calculation apparatus of the present invention is a point calculation apparatus that calculates a point to be given to a customer who has purchased an item, the point calculation apparatus including:

an information storage module that maps an item, a buy date of the item, and a purchase price of the item to customer information and stores the mapping;

an estimated price computation module that computes an estimated price of an item after a predetermined revision, corresponding to a difference in commercial value of the item before and after the predetermined revision;

a customer information extraction module that retrieves the information storage module and extracts customer information of a customer who has purchased the item within a time period of predetermined days prior to a date of the predetermined revision; and

a point calculation module that calculates a point to be given to the customer, based on a price difference between the purchase price of the item mapped to the extracted customer information and the estimated price of the corresponding item computed by the estimated price computation module.

The second point calculation apparatus of the present invention retrieves the information storage module, in which the mapping of an item, a buy date of the item, and a purchase price of the item to customer information is stored, and extracts customer information of the customer who has purchased the item within a time period of predetermined days prior to a date of the predetermined revision of the item. The second point calculation apparatus then calculates a point given to the customer who has purchased the item, based on a price difference between the purchase price of the item mapped to the extracted customer information and an estimated price of the item after the predetermined revision, which is computed corresponding to a difference in commercial value of the item before and after the predetermined revision of the item. Namely the price difference between the estimated price of the item after the predetermined revision, which is based on the variation in commercial value before and after the predetermined revision of the item, and the purchase price of the item that the customer has paid for the item, is calculated as a point. The calculated point is used as an index of a certain service given to the customer, corresponding to the variation in commercial value of the item before and after the predetermined revision. Here the ‘predetermined revision of the item’ includes either one or both of a price revision and a functional revision of the item.

The second point calculation apparatus of the present invention can further include a point output module that outputs the point calculated by the point calculation module. In the second point calculation apparatus, the point calculation module can calculate the point based on the price difference and the purchase price of the item.

### BRIEF DESCRIPTION OF THE DRAWINGS

FIG. 1 schematically illustrates the construction of a reward system 30 in one embodiment of the present invention;

FIG. 2 is a flowchart showing a revision point setting routine executed by any of multiple customer management terminals 36 in the case of a price revision or a functional revision of an item;

FIG. 3 shows price variations of items before and after price revision of the items and points set relative to the price variations, as an example;

FIG. 4 shows functional variations of parts constituting an item before and after functional revision of the item and points set relative to the functional variations, as an example;

FIG. 5 is a flowchart showing a purchase point setting routine executed by any of the multiple customer management terminals 36 in the case of a price revision of an item or in the case of setting a price of a new item;

FIG. 6 shows an example of purchase points;

FIG. 7 is a flowchart showing a revision point accumulation routine executed by a customer management computer 34;

FIG. 8 is a flowchart showing a purchase point accumulation routine executed by the customer management computer 34;

FIG. 9 is a flowchart showing a my page output routine executed by a Web server 32;

FIG. 10 shows an input dialog box of an ID and a password for output of my page;

FIG. 11 shows an example of my page;

FIG. 12 is a flowchart showing a point notification routine executed by the Web server 32; and

FIG. 13 shows an E mail including a list of points accumulated and an available discount.

### DESCRIPTION OF THE PREFERRED EMBODIMENTS

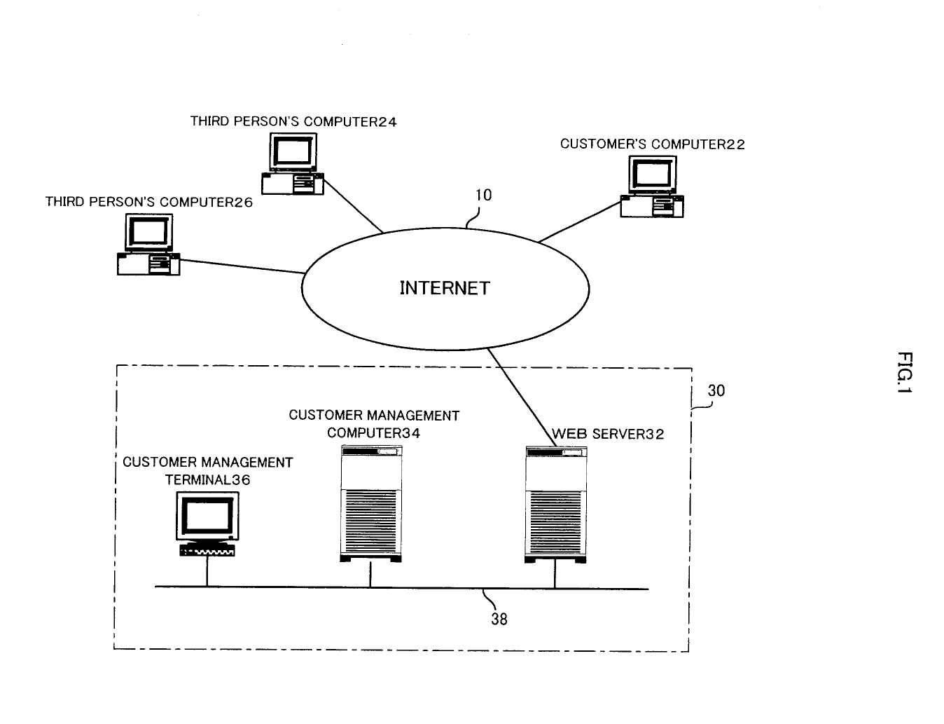

One mode of carrying out the present invention is discussed below as a preferred embodiment. FIG. 1 schematically illustrates the construction of a reward system 30 in one embodiment of the present invention. The reward system 30 of this embodiment includes a Web server 32 that is connected to the Internet 10 as a public network and is accessible by a customer's computer 22 and third person's computers 24 and 26, a customer management computer 34 that stores individual information of each customer and information with regard to items purchased by the customer and manages data related to the customer, and multiple customer management terminals 36. These constituents are mutually connected via a private LAN 38.

The Web server 32 stores commercial point information and outputs all or part of the commercial point information, which is to be displayed in my page allocated to the customer on the customer's computer 22, in response to a request from the customer's computer 22 via the Internet 10. The commercial point information includes item-related information like the customer ID, the item purchased by the customer, the version-up record of the item, and the trouble record of the item, as well as point information like the point allocated to a price revision or a functional revision of the item and the buy date of the item. The Web server 32 provides the customer with such information, while opening a commodity sales and mending site to the public to accept purchase orders and mending orders of items.

The customer management computer 34 functions as a database for storing customer information input with any of the multiple customer management terminals 36 connected via the private LAN 38. The customer information includes individual information like the name, the address, the telephone number, the mail address, the age, and the occupation of the customer, as well as the item-related information discussed above. The customer management computer 34 also calculates a point to be given to the customer, based on a point input and set with any of the multiple customer management terminals 36 in the case of a price revision or a functional revision of an item. The calculated point is stored as part of the individual information of the customer. The functional revision of an item means alteration of the specification of the item and may be or may not be accompanied with a price revision.

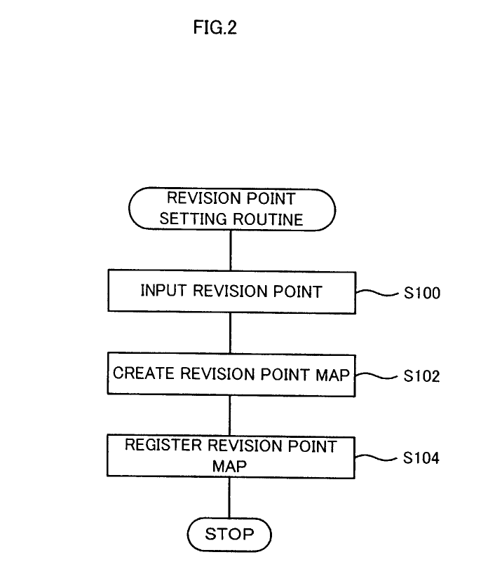

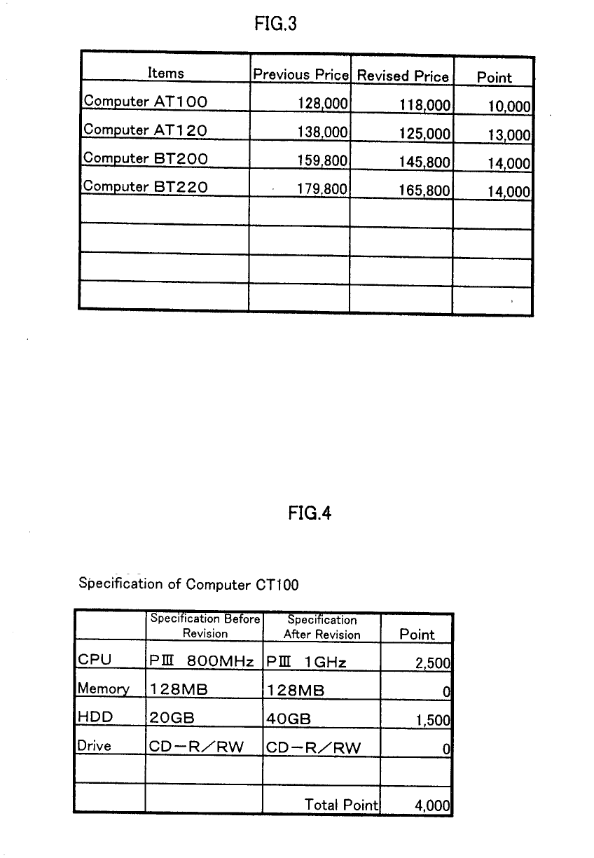

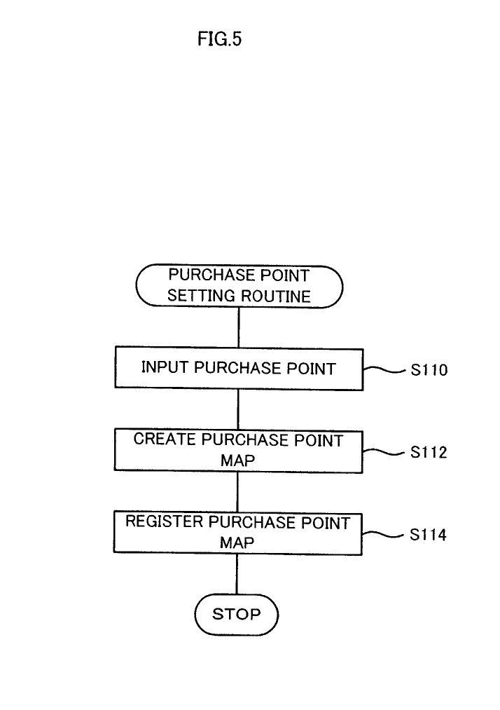

The following describes series of processing executed in the reward system 30 of the embodiment thus constructed, especially a point setting process and a point calculation process. FIG. 2 is a flowchart showing a revision point setting routine executed by any of the multiple customer management terminals 36 in the case of a price revision or a functional revision of an item. When the program enters the revision point setting routine, the customer management terminal 36 first inputs a revision point (step S100). In the case of a price revision of an item, the procedure inputs the revision point specified according to the previous price and the revised price. In the case of a functional revision of an item, that is, when any part of the item is replaced with a new part or the function of any part is improved without the price revision, the procedure inputs the revision point specified according to the replaced part or the improved function. FIG. 3 shows price variations of items before and after price revision of the items and points set relative to the price variations, as an example. FIG. 4 shows functional variations of parts constituting an item before and after functional revision of the item and points set relative to the functional variations, as another example. In the example of FIG. 3, the variation in price of each item before and after the price revision is set to the revision point. In the example of FIG. 4, the variation in price of each part before and after the functional revision is set to the revision point. The functional revision of the item may replace any part of the item with a new part or improve the function of any part without or with a price revision. In the latter case, the revision point may be specified, based on the replaced part and the improved function as well as the revised price.

After input of the revision points, the customer management terminal 36 creates a list of the input revision points or a revision point map (step S102), and registers the created revision point map into the customer management computer 34 (step S104). One example of the revision point map relates the points to the items as shown in FIG. 3. Another example of the revision point map relates the points to the parts as shown in FIG. 4. The customer management terminal 36 transmits a command for registration of the revision point map to the customer management computer 34, while outputting the revision point map to the customer management computer 34 to implement registration of the revision point map. The customer management computer 34 receives the transmitted command for registration of the revision point map and the output revision point map from the customer management terminal 36, and stores the input revision point map into a predetermined area of a hard disk (not shown).

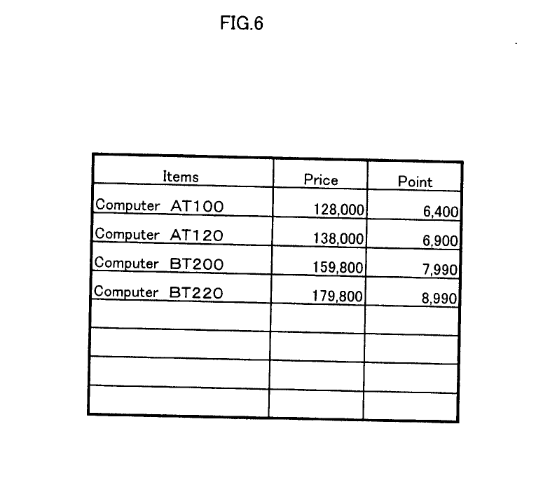

The reward system 30 of the embodiment accumulates a point allocated to purchase of each item (hereinafter referred to as purchase point), in addition to the revision point allocated to the price revision or the functional revision of the item. Like the revision points, the purchase points are set in response to input from any of the multiple customer management terminals 36. FIG. 5 is a flowchart showing a purchase point setting routine executed by any of the multiple customer management terminals 36 in the case of a price revision of an item or in the case of setting a price of a new item. The processing of steps S110 through S114 in the purchase point setting routine of FIG. 5 is similar to the processing of steps S100 through S104 in the revision point setting routine of FIG. 2 discussed above, except that the revision point in FIG. 2 is replaced by the purchase point in FIG. 5. The detailed explanation of the purchase point setting process is accordingly omitted. In this embodiment, 5% of the price of each item is set to the purchase point as shown in FIG. 6.

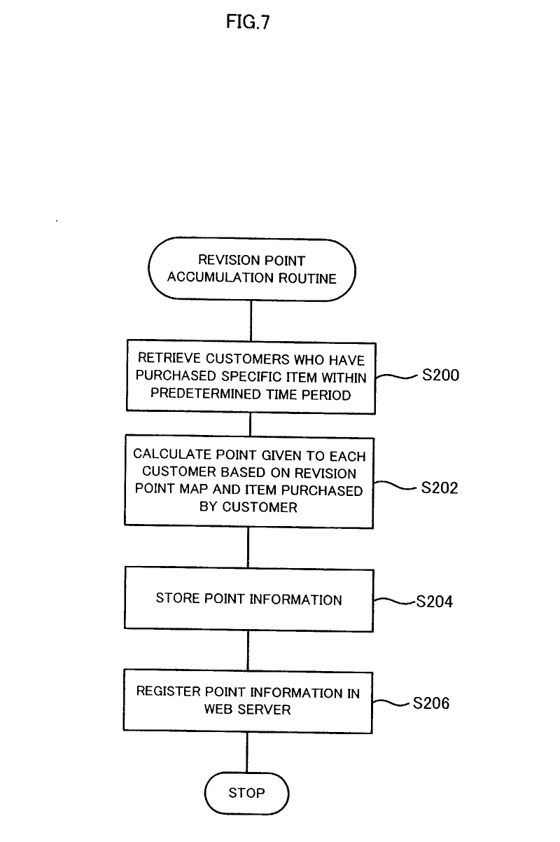

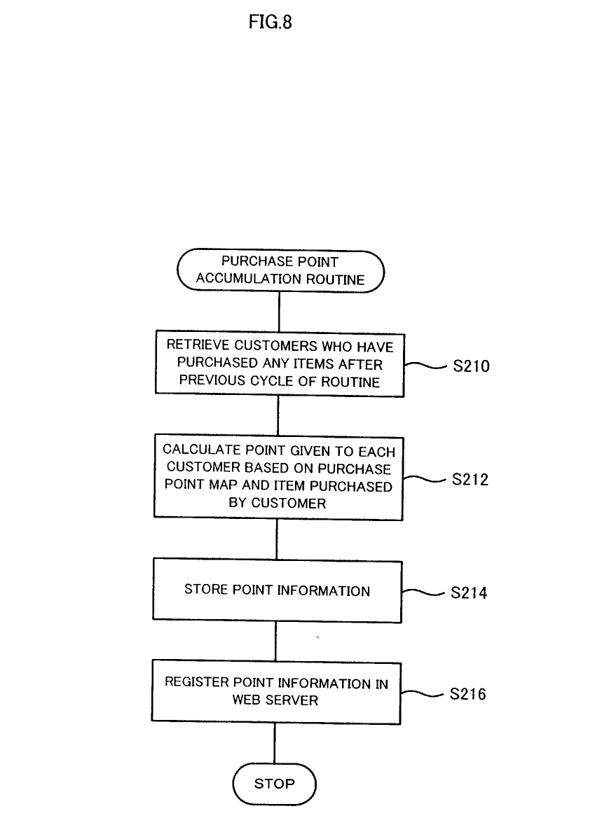

The following describes a revision point accumulation process and a purchase point accumulation process executed by the customer management computer 34. FIG. 7 is a flowchart showing a revision point accumulation routine executed by the customer management computer 34. This routine is activated when there is a price revision or a functional revision of an item and the revision point map is registered in the customer management computer 34. When the program enters the revision point accumulation routine, the customer management computer 34 first retrieves each customer who has purchased the item within a predetermined time period prior to a date of the price revision or the functional revision of the item (step S200). The predetermined time period is specified as a time span in which the customer who has purchased the item prior to the price revision or the functional revision is expected to have feeling of loss due to such revision. The predetermined time period depends upon the life cycle of the item. In this embodiment, the item is a computer having a relatively short life cycle. The predetermined time period is accordingly set equal to 7 days. The processing of step S200 in this embodiment thus retrieves each customer who has purchased the item within 7 days prior to the revision.

After retrieval of the relevant customers, the customer management computer 34 calculates a point to be given to each customer, based on the registered revision point map and the item purchased by the customer (step S202) For example, when there is price revision of items as shown in FIG. 3 and the customer has purchased a computer AT120 within 7 days prior to the price revision, a point 13,000 is given to the customer. In another example, when there is functional revision of items as shown in FIG. 4 and the customer has purchased a computer CT100 within 7 days prior to the functional revision, a point 4,000 is given to the customer.

The customer management computer 34 subsequently stores point information representing the calculated point and the buy date of the item as part of the customer information (step S204), and registers the point information as part of the commercial point information in the Web server 32 (step S206). The customer management computer 34 transmits a command for registration of the point information to the Web server 32, while outputting the point information to the Web server 32 to implement registration of the point information. The Web server 32 receives the transmitted command for registration of the point information and the output point information from the customer management computer 34, and stores the input point information as part of the commercial point information in a hard disk (not shown).

The purchase point accumulation process is iteratively carried out at preset time intervals (for example, at every week) according to a flowchart shown in FIG. 8. When the program enters the purchase point accumulation routine, the customer management computer 34 first retrieves each customer who has purchased any item after a previous cycle of this processing (step S210). In the case where the purchase point accumulation process is carried out at every week, this procedure retrieves all customers who have purchased any items within one week after execution of the previous cycle of the purchase point accumulation process. The customer management computer 34 calculates a point to be given to each retrieved customer, based on the item purchased by the customer and the purchase point map (step S212). The customer management computer 34 then stores point information representing the calculated point allocated to purchase of the item and the buy date of the item as part of the customer information (step S214), and registers the point information as part of the commercial point information in the Web server 32 (step S216). The processing of steps S212 through S216 in the purchase point accumulation routine of FIG. 8 is similar to the processing of steps S202 through S206 in the revision point accumulation routine of FIG. 7. The calculation of the point at step S212 may follow the mapping of the points to the prices of items shown in FIG. 6. For example, when the customer has purchased a computer AT120, a point 6,900 is given to the customer.

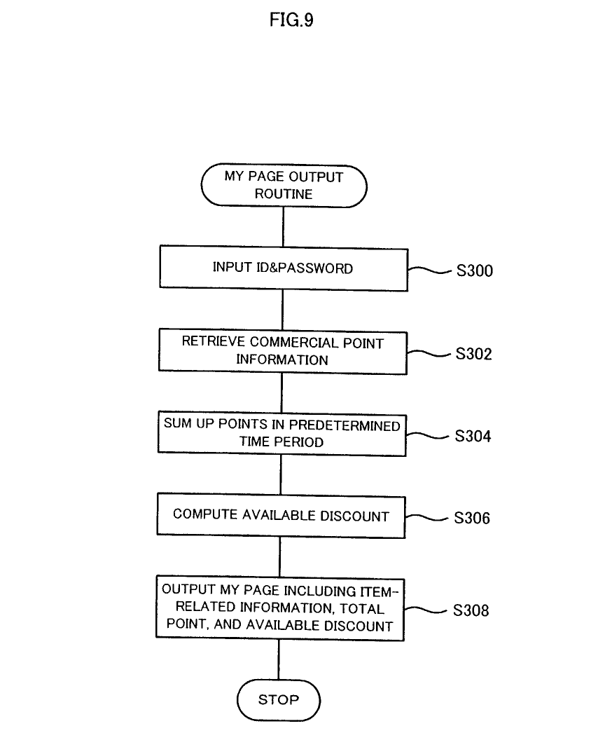

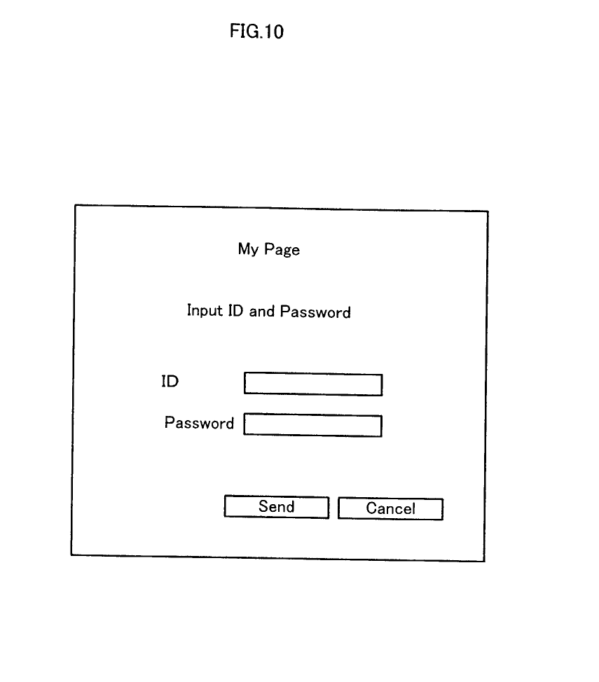

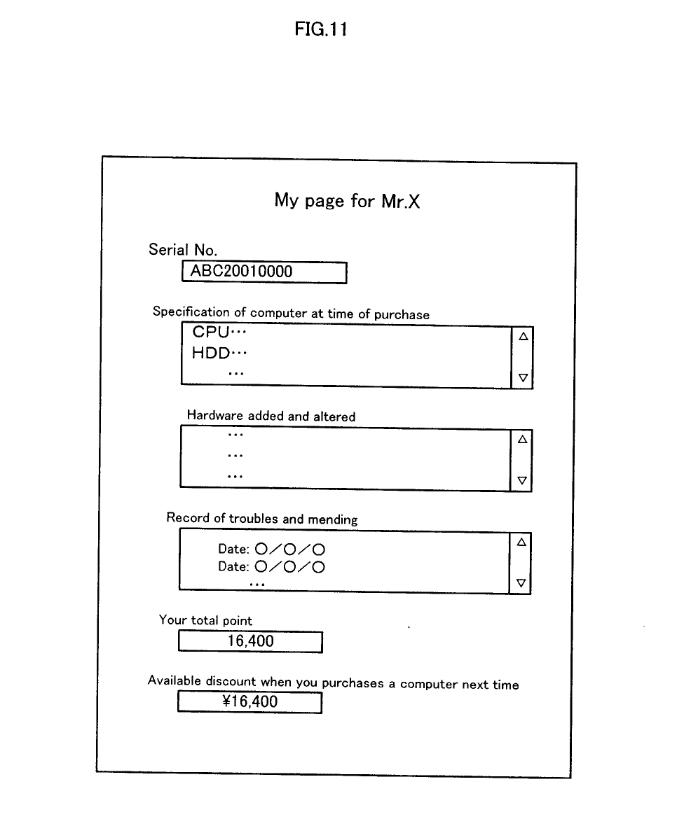

The following describes a my page output process including output of a total point. FIG. 9 is a flowchart showing a my page output routine executed by the Web server 32. This routine is activated when the customer gains access to the Web server 32 via the Internet 10 and requests output of a specific page allocated to the customer (hereinafter referred to as my page). When the program enters the my page output routine, the Web server 32 first receives input of an ID and a password (step S300). FIG. 10 shows an example of a log-in process window, that is, an input dialog box of the ID and the password for output of my page. The customer enters the ID and the password in the input dialog box and clicks a ‘Send’ button to input the ID and the password into the Web server 32.

After input of the ID and the password, the Web server 32 retrieves the commercial point information of the customer using the input ID (step S302) and sums up the points given and registered to the items purchased within a predetermined time period (for example, within 3 years) based on the point information included in the retrieved commercial point information (step S304). As described above, the point information includes points given to the items according to the revision point map and the purchase point map and the buy dates of the respective items. The procedure accordingly extracts the points given to the items having the buy dates within the predetermined time period and sums up the extracted points. The Web server 32 subsequently computes a discount available as one of the point-based services from the total point (step S306). The discount represents a sum of money substitutable from a price when the customer purchases any item next time.

After computation of the discount, the Web server 32 outputs my page including part of the item-related information in the commercial point information, the total point, and the computed discount (step S308). The program then exits from the my page output routine. FIG. 11 shows an example of the output my page. In this example, when the customer has purchased a computer AT100 within 7 days prior to the price revision as shown in FIG. 3, a total point and an available discount, which is calculated from the total point and is given when the customer purchases a computer next time, are displayed. The total point is a sum of a point 10,000 set according to the input revision point map of FIG. 3 and a point 6,400 set according to the input purchase point map of FIG. 6. The total point is directly specified as the available discount at a conversion rate of 1 to 1.

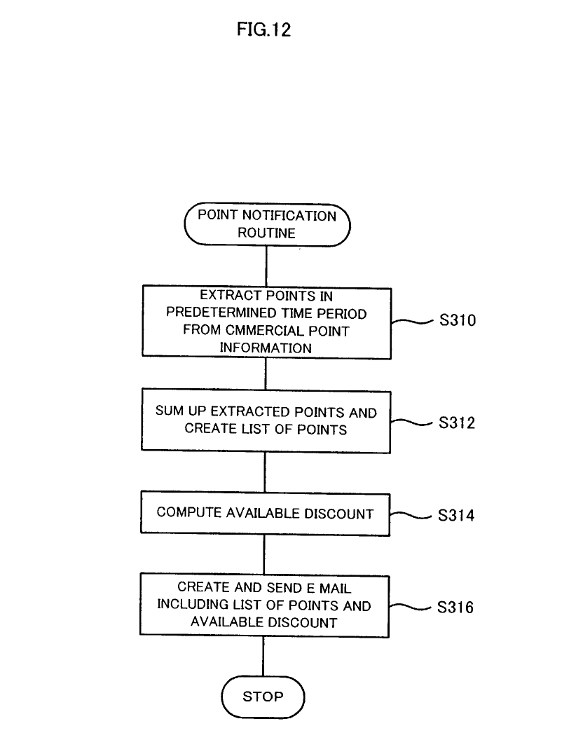

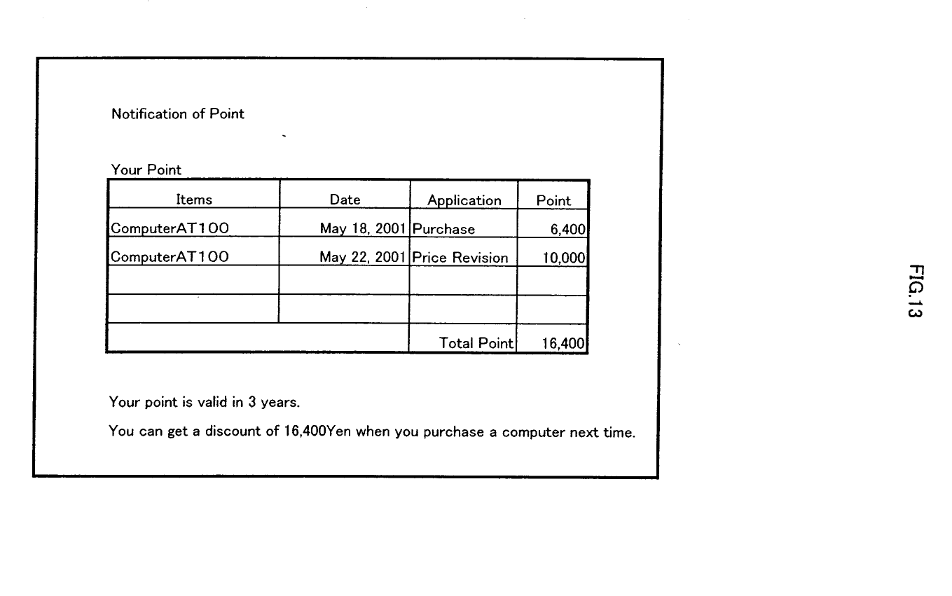

The following description regards a point notification process to notify the customer of the stored point. FIG. 12 is a flowchart showing a point notification routine executed by the Web server 32. This routine is iteratively carried out at preset time intervals (for example, at every 3 months). When the program enters the point notification routine, the Web server 32 first extracts the points in a predetermined time period (for example, in 3 years) from the stored commercial point information (step S310), and sums up the extracted points and creates a list of the extracted point (step S312). The Web server 32 then computes a discount as one of the available point-based services from the total point (step S314). The summation of the points and the computation of the discount are described above. The Web server 32 subsequently creates an E mail including the list of the points and the available discount and sends the E mail to the customer (step S316). The address of the E mail may be the mail address stored as part of the commercial point information in the Web server 32 or may be read from the customer information stored in the customer management computer 34. FIG. 13 shows an E mail including a list of points and a available discount. The Email of this example is based on the points and the discount in my page shown in FIG. 11.

As described above, the reward system 30 of the embodiment gives a certain point to the customer who has purchased an item immediately before a price revision or a functional revision of the item. The point is displayed on my page allocated to the customer. This arrangement facilitates the customer's enquiry about the accumulated point, while effectively preventing leakage of the individual information of the customer to any third person. As one of the point-based services, the reward system 30 of the embodiment displays an available discount given to the customer when the customer purchases any item next time. This arrangement desirably wipes out the customer's feeling of loss who has purchased an item immediately before the price revision or the functional revision of the item.

The reward system 30 of the embodiment regularly notifies each customer of the accumulated point by E mail. The customer can thus check the available point on a regular basis. The reward system 30 of the embodiment accumulates the purchase point of the item and the revision point allocated to the price revision or the functional revision of the item.

The reward system may accumulate any other point, such as a mending point allocated to mending of the item, in addition to the purchase point of the item and the revision point allocated to the price revision or the functional revision of the item. The reward system may alternatively accumulate only the revision point allocated to the price revision or the functional revision of the item.

When a price revision or a functional revision of an item occurs, the reward system 30 of the embodiment inputs the point set corresponding to a variation in price or function of the item before and after the revision as a revision point, and calculates a point to be given to the customer who has purchased the item within a predetermined time period prior to the revision. In the case of a price revision or a functional revision of an item, one modified procedure may compute an estimated price of the item after the revision and calculate the point to be given to the customer who has purchased the item within a predetermined time period prior to the revision, based on a price difference between the purchase price of the item that the customer has paid for the item and the estimated price. The estimated price is identical with the revised price in the case of the price revision of the item. In the case of the functional revision of the item, the estimated price is calculated from prices of replaced parts. The price difference between the purchase price of the item that the customer has paid for the item and the estimated price may be specified directly as the point to be given to the customer, or may be multiplied by a preset coefficient for calculation of the point.

The reward system 30 of the embodiment regularly notifies each customer of the accumulated point by E mail. One possible modification may notify only each relevant customer of the accumulated point when a certain point is allocated to the price revision or the functional revision of the item. Another possible modification may notify only each relevant customer of the accumulated point when the customer has purchased a certain item. Each customer is notified of the accumulated point by E mail in the reward system 30 of the embodiment, but the notification may be performed by post or any other suitable means. The notification may even be omitted, if not required.

The reward system 30 of the embodiment gives a discount on price of an item corresponding to the accumulated point, when the customer purchases the item. The point-based service given to the customer is, however, not restricted to the discount, but may be any appropriate reward corresponding to the accumulated point, for example, a gift, cash, a cash voucher, and replacement with an optional item.

The reward system 30 of the embodiment restricts the accumulation of points in a preset time period (for example, 3 years) and sets the validated date of the accumulated point. One possible modification may not restrict the accumulation of points in any time period nor set any expiration date of the accumulated point.

In the reward system 30 of the embodiment, the customer management terminal 36 executes the revision point setting process and the purchase point setting process. The customer management computer 34 or the Web server 32 may alternatively carry out these processes. In the latter case, the customer management terminals 36 are not required to be incorporated in the reward system 30. In the reward system 30 of the embodiment, the customer management computer 34 executes the revision point accumulation process and the purchase point accumulation process. The Web server 32 may alternatively carry out these processes. In the latter case, the customer management computer 34 is not required to be incorporated in the reward system 30. In the modified configuration, the reward system may include only the Web server 32, whereas the reward system 30 of the embodiment includes the Web server 32, the customer management computer 34, and the customer management terminals 36.

The embodiment regards the reward system according to the present invention. The technique of the present invention is also applicable to a point calculation apparatus that calculates the revision point and the purchase point, as well as a computer program that causes a computer to function as the point calculation apparatus for calculating the revision point and the purchase point.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. A reward system that gives a point to a customer who has purchased an item, said reward system comprising:
a revision point setting module that, in the case of a predetermined revision of an item, sets a variation in balance between a commercial value and a price of the item before and after the predetermined revision, as a revision point; and
a point calculation module that calculates a point to be given to a customer who has purchased the item, based on the item purchased within a time period of predetermined days prior to a date of the predetermined revision and the revision point set by said revision point setting module.

2. A reward system in accordance with claim 1, wherein the predetermined revision of the item includes a price revision of the item and a functional revision of the item.

3. A reward system in accordance with claim 1, wherein said point calculation module calculates the point to be given to the customer, based on the revision point set by said revision point setting module in a predetermined time period.

4. A reward system in accordance with claim 1, said reward system further comprising:
a point output module that outputs the point calculated by said point calculation module.

5. A reward system in accordance with claim 4, wherein said point output module outputs the calculated point, in response to a request of the customer under a preset condition via a public network.

6. A reward system in accordance with claim 1, said reward system further comprising:
a service setting module that sets a predetermined service corresponding to the point calculated by said point calculation module.

7. A reward system in accordance with claim 6, wherein the predetermined service gives a discount on price of an item corresponding to the calculated point, when the customer purchases the item.

8. A reward system in accordance with claim 6, said reward system further comprising:
a service specification output module that outputs specification of the predetermined service set by said service setting module.

9. A reward system in accordance with claim 8, wherein said service specification output module outputs the specification of the predetermined service in response to a request of the customer under a preset condition via a public network.

10. A reward system in accordance with claim 1, said reward system further comprising:
a purchase point setting module that sets a purchase point relative to a purchase price of an item,
wherein said point calculation module calculates the point to be given to the customer based on the revision point, while calculating the point to be given to the customer who has purchased the item based on the purchased item and the purchase point set by said purchase point setting module.

11. A reward system in accordance with claim 10, wherein said point calculation module calculates the point to be given to the customer, based on the purchase point set by said purchase point setting module in a predetermined time period.

12. A reward system in accordance with claim 1, said reward system further comprising:
an individual information storage module that stores individual information of the customer; and
a point notification module that notifies the customer of the point calculated by said point calculation module to be given to the customer, using the individual information of the customer stored in said individual information storage module.

13. A reward system in accordance with claim 12, wherein said point notification module notifies the customer of the calculated point by an E mail.

14. A point calculation apparatus that calculates a point to be given to a customer who has purchased an item, said point calculation apparatus comprising:
a revision point input module that inputs a revision point, which is set corresponding to a variation in balance between a commercial value and a price of an item before and after a predetermined revision of the item; and
a point calculation module that calculates a point to be given to a customer who has purchased the item, based on the revision point input by said revision point input module and the item purchased within a time period of predetermined days prior to a date of the predetermined revision.

15. A point calculation apparatus in accordance with claim 14, wherein the predetermined revision of the item includes a price revision of the item and a functional revision of the item.

16. A point calculation apparatus in accordance with claim 14, wherein said point calculation module calculates a point corresponding to the predetermined revision of the item carried out in a predetermined time period.

17. A point calculation apparatus in accordance with claim 14, said point calculation apparatus further comprising:
a point output module that outputs the point calculated by said point calculation module.

18. A point calculation apparatus in accordance with claim 14, wherein said point output module outputs the calculated point, in response to a request of the customer under a preset condition via a public network.

19. A point calculation apparatus in accordance with claim 14, said point calculation apparatus further comprising:
a purchase point input module that inputs a purchase point set relative to a purchase price of an item,
wherein said point calculation module calculates the point to be given to the customer based on the revision point, while calculating a point to be given to the customer who has purchased the item based on the purchased item and the purchase point input by said purchase point input module.

20. A point calculation apparatus in accordance with claim 19, wherein said point calculation module calculates a point assigned to the item purchased in a predetermined time period.

21. A point calculation apparatus that calculates a point to be given to a customer who has purchased an item, said point calculation apparatus comprising:
an information storage module that maps an item, a buy date of the item, and a purchase price of the item to customer information and stores the mapping;
an estimated price computation module that computes an estimated price of an item after a predetermined revision, corresponding to a difference in commercial value of the item before and after the predetermined revision;
a customer information extraction module that retrieves said information storage module and extracts customer information of a customer who has purchased the item within a time period of predetermined days prior to a date of the predetermined revision; and
a point calculation module that calculates a point to be given to the customer, based on a price difference between the purchase price of the item mapped to the extracted customer information and the estimated price of the corresponding item computed by said estimated price computation module.

22. A point calculation apparatus in accordance with claim 21, wherein the predetermined revision of the item includes a price revision of the item and a functional revision of the item.

23. A point calculation apparatus in accordance with claim 21, said point calculation apparatus further comprising:
a point output module that outputs the point calculated by said point calculation module.

24. A point calculation apparatus in accordance with claim 21, wherein said point calculation module calculates the point based on the price difference and the purchase price of the item.
